(19) United States
(12) Patent Application Publication
(10) Pub. No.: US 2026/0148594 A1
(43) Pub. Date: May 28, 2026

(54) Control Device and Method for Controlling the Operation of a Motor Vehicle Before and During a Refueling Process

(71) Applicant: Bayerische Motoren Werke Aktiengesellschaft, Muenchen (DE)

(72) Inventors: Andreas BACHERLER, Kaufbeuren (DE); Nils EULENBACH, Eching (DE); Kilian LUDWICZEK, Muenchen (DE)

(21) Appl. No.: 19/177,749

(22) Filed: Apr. 14, 2025

(30) Foreign Application Priority Data
Apr. 29, 2024 (DE) 10 2024 111 977.2

(51) Int. Cl. G07C 5/08; B60L 58/30; B60Q 1/50; B60S 5/02; H01M 8/04303

(52) U.S. Cl. CPC G07C 5/0825; B60L 58/30; B60Q 1/543; B60S 5/02; G07C 5/0833; H01M 8/04303; H01M 2250/20

(57) ABSTRACT

A control device for controlling the operation of a motor vehicle before and during a refueling process is provided. The control device is configured to detect a request to carry out the refueling process, initiate preparation of the motor vehicle for the refueling process as soon as the request to carry out the refueling process has been detected, activate at least one lighting device and/or output device of the motor vehicle to output at least one first signal as soon as the preparation has been initiated, and activate the at least one lighting device and/or output device, to either output at least one second signal if the initiated preparation has been completed without error and the refueling process can be started, or output at least one third signal if the initiated preparation has not been completed without error and the refueling process is not possible.

### CROSS REFERENCE TO RELATED APPLICATION

This application claims priority under 35 U.S.C. § 119 from German Patent Application No. 10 2024 111 977.2, filed Apr. 29, 2024, the entire disclosure of which is herein expressly incorporated by reference.

### BACKGROUND AND SUMMARY

The present disclosure relates to a control device for controlling the operation of a motor vehicle before and during a refueling process of the motor vehicle, a motor vehicle comprising the control device, and a method for controlling the operation of a motor vehicle before and during a refueling process of the motor vehicle. In addition, or as an alternative, a computer program is provided, which comprises commands which, when the program is executed by a computer, cause the computer to execute the method at least in part. In addition, or as an alternative, a non-transitory computer-readable medium is provided, which comprises commands which, when the commands are executed by a computer, cause the computer to execute the method at least in part.

In conventional motor vehicles, a refueling process is started by directly opening the respective fuel filler cap. In normal cases, an immediate opening is possible, so that a refueling process can be carried out without delay.

However, this is not possible for fuel cell vehicles, for example, because the respective fuel cell must be switched off during a refueling process, due to regulations among other reasons. The fuel cell shutdown process takes a certain amount of time, so that the fuel filler cap must remain closed until then. This results in a waiting period until the refueling process can be started.

In addition to the waiting time, other technical reasons can apply which also mean that the refueling process cannot always be started immediately for technical reasons. In such situations, the user usually has no way to understand the situation, for example, why the fuel filler cap cannot be opened.

Against the background of this prior art, an object of the present disclosure is to specify a device and a method which are suitable for enhancing the prior art.

The object is achieved by the features of the independent claims. The content of each of the subordinate claims and the dependent claims is optional developments of the disclosure.

Accordingly, the object is achieved by a control device for controlling the operation of a motor vehicle before and during a refueling process of the motor vehicle.

The control device is designed to detect a request to carry out the refueling process (e.g., while the motor vehicle is stationary).

The control device is designed to initiate the preparation of the motor vehicle for the refueling process as soon as the request to carry out the refueling process has been detected.

The control device is designed to activate at least one lighting device and/or output device of the motor vehicle to output at least one first signal as soon as the preparation has been initiated.

The control device is designed to activate the at least one lighting device and/or output device, either to output at least one second signal if the initiated preparation has been completed without error and the refueling process can be started, or to output at least one third signal if the initiated preparation has not been completed without error and the refueling process is not possible. The at least one first signal, the at least one second signal and the at least one third signal are visual and/or acoustic signals that differ from one another.

The control device or control unit may be part of the driving assistance system or represent it. For example, the control device may be an electronic control unit (ECU). The electronic control unit may be an intelligent processor-controlled unit, which can communicate with other modules, for example via a central gateway (CGW), and which may form the vehicle on-board electrical system by means of field buses, such as the CAN bus, LIN bus, MOST bus, FlexRay and/or via the automotive Ethernet, for example together with telematics control units and/or an environmental sensor system.

It is conceivable that, for the driving behavior of the motor vehicle, the control device controls relevant functions, such as the steering, the engine control, the power transmission and/or the braking system. In addition, driver assistance systems, such as a parking assistance system, adaptive cruise control (ACC), a lane keep assistance system, a lane change assistance system, a traffic sign recognition system, a light signal recognition system, a start-up assistance system, a night vision assistance system and/or an intersection assistance system, for example, can be controlled by the control device.

The control device described above offers a number of advantages. Among other things, an improved technology is provided that enables a user, e.g., the driver of the vehicle, to be adequately informed before and, if necessary, during a refueling process in order to understand the situation and to be able to react or act correctly. Specifically, the user can be informed on the basis of the various signals, e.g., at the location of the user interaction (e.g., on a fuel filler cap of the motor vehicle, which the user wants to open or is opening for the refueling process), if his/her request to carry out the refueling process has been detected and the subsequently initiated preparation for the refueling process has been completed without error or if an error has occurred. For example, when the user is at the fuel filler cap, the user can use the various signals to identify when he/she can start the refueling process or if a refueling process is not possible due to an error.

Possible further developments of the control device described above are explained in detail below.

The motor vehicle can be a fuel cell vehicle. The control device can be designed to verify during the initiated preparation whether a shutdown of a fuel cell system of the fuel cell vehicle has been completed without error. The control device can be designed to determine that the initiated preparation has been completed without error, provided that the shutdown has been completed without error.

The control device can be designed to detect the request to carry out the refueling process by detecting a tapping on and/or an attempt to open a fuel filler cap of the motor vehicle.

The at least one first signal, the at least one second signal and the at least one third signal can be perceptible outside the motor vehicle and/or on a fuel filler cap of the motor vehicle.

The control device can be designed to initiate and/or permit the opening of a fuel filler cap of the motor vehicle if the initiated preparation has been completed without error and the refueling process can be started.

The control device may be configured to activate the at least one lighting device and/or output device to output at least a fourth signal when the refueling process has been completed.

The at least one lighting device can comprise an exterior lighting and/or an interior lighting of the motor vehicle for outputting the at least one first signal, the at least one second signal and the at least one third signal (and optionally the at least one fourth signal) as visual signals that differ from one another.

The at least one output device can comprise a loudspeaker device of the motor vehicle for outputting the at least one first signal, the at least one second signal and the at least one third signal (and optionally the at least one fourth signal) as acoustic signals that differ from one another.

The at least one first signal may comprise a flashing of the at least one lighting device, for example, the exterior lighting and/or the interior lighting, with a predetermined first frequency. For example, the exterior and interior lights may flash simultaneously (or synchronously) at the first frequency, wherein, for example, the interior lights may have different colors and may flash with a blue-green color, for example.

The at least one first signal may comprise an output of a first tone by at least one output device, for example, the loudspeaker device.

The at least one second signal may comprise a permanent illumination of the exterior lighting (e.g., during the entire refueling process). Alternatively, or in addition, the at least one second signal may comprise the output of a second tone which is different from the first tone by the loudspeaker device, and/or a flaring or a brief strong illumination of the interior lighting.

The at least one third signal may include flashing of the at least one lighting device, for example, the exterior lighting and/or the interior lighting, with a predetermined second sequence which differs from the first frequency, and optionally subsequently switching off the at least one lighting device. Alternatively or in addition, the at least one third signal may comprise the output of a warning tone by the loudspeaker device.

The at least one fourth signal can comprise switching off the exterior lighting and/or switching off, or at least a simple (e.g., double) flashing, of the interior lighting.

The at least one fourth signal can comprise the output of a third tone, which is different from the first and/or second tones, by the loudspeaker device. For example, the third tone may be a confirmation tone that the fuel filler cap is closed. It is conceivable that the loudspeaker device can also emit a fourth tone before the end of the refueling process, which is different from the third tone and can be, for example, a confirmation tone that the tank of the motor vehicle is full.

The control device may be designed to activate a display screen in an interior of the motor vehicle to output information about a status of the preparation of the motor vehicle and a status of the refueling process. It is conceivable that the control device could be configured to activate the screen to output an error message and, for example, information about a fault (which has occurred during the initiated preparation) if the initiated preparation has not been completed without error. For example, the information may include instructions for correcting the fault.

As mentioned above, the motor vehicle can be a fuel cell vehicle. The control device may be configured to obtain a current position of the fuel cell vehicle while the fuel cell vehicle is in driving mode (or in motion), and to retrieve digital map data, wherein the digital map data indicates positions of hydrogen filling stations.

The control device may be designed to determine, based on the obtained current position of the fuel cell vehicle and the retrieved digital map data, whether one of the hydrogen filling stations is located in the vicinity of the fuel cell vehicle and/or whether the fuel cell vehicle is approaching one of the hydrogen filling stations.

The control device may be designed to predict a potentially imminent refueling process of the fuel cell vehicle if it has been determined that one of the hydrogen filling stations is located in the vicinity of the fuel cell vehicle and/or that the fuel cell vehicle is approaching one of the hydrogen filling stations.

The control device can be designed to initiate a shutdown of a fuel cell system of the fuel cell vehicle if the potentially imminent refueling process has been predicted.

This enables, among other advantages, an improved technology to be provided which makes it possible to start a refueling process of the fuel cell vehicle as far as possible without waiting time or delay. By initiating a shutdown of the fuel cell system of the fuel cell vehicle pre-emptively and at an early stage while the fuel cell vehicle is still in driving mode and moving toward a hydrogen filling station, it is ensured that the shutdown process has been completed by the time the fuel cell vehicle has reached the hydrogen filling station and a user, such as the driver, wants to start the filling process.

The current position of the fuel cell vehicle (e.g., based on GPS position data) and the digital map data can be provided by a navigation device in the fuel cell vehicle. The navigation device can be understood to mean a device which uses the current position and the digital map data to allow route creation and guidance to a selected destination. The destination can be selected or specified by a user, e.g., via an input unit of the fuel cell vehicle. The digital map data can include information on road networks and points of interest (POIs), wherein the places of interest can include hydrogen filling stations (or their locations). The digital map data can be retrieved, for example, from a memory in the navigation device or in the fuel cell vehicle and/or from external devices.

The control device may be configured to initiate the shutdown of the fuel cell system in such a way that the shutdown process is completed upon arrival at one of the hydrogen filling stations and/or a refueling process of the fuel cell vehicle can be carried out upon arrival at one of the hydrogen filling stations without a waiting time.

The control device may be designed to initiate the shutdown process of the fuel cell system depending on a driving speed of the fuel cell vehicle, a remaining distance of the fuel cell vehicle to one of the hydrogen filling stations and/or an expected remaining driving time of the fuel cell vehicle to one of the hydrogen filling stations.

The control device may be designed to initiate the shutdown process of the fuel cell system provided that a traction battery of the fuel cell vehicle has a sufficient state of charge for operating an electric motor of the fuel cell vehicle until the fuel cell vehicle can reach one of the hydrogen filling stations.

What is described above may be summarized in other words and with reference to a possible more concrete embodiment of the disclosure as described below, with the following description being interpreted as not limiting to the disclosure.

Hydrogen filling stations can be considered points of interest (POIs). This means that it can be determined in advance whether the motor vehicle is at or near a hydrogen filling station. For this purpose, the fuel cell or the fuel cell system can be switched off pre-emptively using the operating strategy via the detection of the POI.

For example, the motor vehicle can drive to a hydrogen filling station. The POI can be recognized and a signal can be transmitted (e.g., to an operation coordinator), which causes the fuel cell or fuel cell system of the motor vehicle to shut down. The motor vehicle can drive by means of an electric motor to a fuel dispenser of the hydrogen filling station, where a refueling request can be expressed (e.g., by tapping on a fuel filler cap of the vehicle from the outside). Due to the pre-emptive shutdown of the fuel cell, the fuel filler cap can open without delay, i.e., without a waiting time.

In addition or alternatively, for the pre-emptive shutdown a user at the location of a user interaction can be adequately informed in order to be able to understand the situation and react or act correctly.

For example, the user can start a refueling process at the fuel filler cap. Both in a correct state (i.e., OK) and in an incorrect state (i.e., not OK), the user can be informed of the status of the refueling process, e.g., by means of an exterior or interior lighting of the motor vehicle visible from the filler cap, or acoustic and/or visual outputs (via any displays present).

In addition, a motor vehicle is provided which comprises the control device described above.

The motor vehicle can be a fuel cell vehicle. The motor vehicle can comprise a fuel cell system. The fuel cell system may be designed to generate electrical energy for an electric motor (as a propulsion machine for the motor vehicle).

The motor vehicle may comprise the at least one lighting device and/or the at least one output device. The at least one lighting device may include an exterior lighting system and/or an interior lighting system of the motor vehicle. The at least one output device may comprise a loudspeaker device of the motor vehicle.

The motor vehicle may comprise the fuel filler cap, which can be located on (or accessible from), for example, the outside of the motor vehicle. The fuel filler cap can be used as a closure for access to a fuel tank (e.g., hydrogen tank) of the motor vehicle.

The motor vehicle can comprise the navigation device, for example, to provide the current position of the motor vehicle and the digital map data.

The motor vehicle can comprise the display screen inside the motor vehicle.

The control device may be connected for signaling (optionally directly or indirectly, e.g., via an on-board network of the vehicle) to the at least one lighting device, the at least one output device, the fuel cell system, the fuel filler cap, the navigation device and/or the display screen.

The motor vehicle may be automated. The motor vehicle may be designed to undertake longitudinal guidance and/or lateral guidance, at least partially and/or at least temporarily, by means of the control device during automated driving of the motor vehicle.

Automated driving can be carried out in such a way that the motor vehicle's movement is (largely) autonomous. Automated driving can be controlled at least partially and/or temporarily by the control device.

It is conceivable that the motor vehicle engages in the lateral guidance of the motor vehicle actively by means of a driving assistance system, e.g., by adjusting an actual steering wheel position, and optionally passively, e.g., by displaying a turn-off instruction.

The motor vehicle can be a motor vehicle of autonomy level 0, i.e., the driver assumes the dynamic driving task even if supporting systems (e.g., ABS or ESP) are present.

The motor vehicle can be a motor vehicle of autonomy level 1, that is, have certain driver assistance systems that assist the driver in the operation of the vehicle, such as adaptive cruise control (ACC).

The motor vehicle may be a motor vehicle of autonomy level 2, that is, partially automated such that functions such as automatic parking, lane maintenance or lateral guidance, general longitudinal guidance, acceleration and/or braking are performed by driver assistance systems.

The motor vehicle may be a motor vehicle of autonomy level 3, that is, conditionally automated such that the driver does not have to continuously monitor the motor vehicle. The motor vehicle independently carries out functions such as triggering the indicator, lane changing and lane maintenance. The driver can attend to other activities, but is prompted by the system when necessary to assume control within a pre-warning period.

The motor vehicle may be a motor vehicle of autonomy level 4, i.e., be so highly automated that the guidance of the vehicle is permanently assumed by the vehicle system. If the driving tasks are no longer manageable by the system, the driver may be prompted to take over control.

The motor vehicle may be a motor vehicle of autonomy level 5, that is, fully automated such that the driver is not required to carry out the driving task. Apart from setting the destination and starting the system, no human intervention is required. The vehicle can do without a steering wheel and pedals.

What has been described above with reference to the control device also applies analogously to the motor vehicle and vice versa.

A method for controlling the operation of a motor vehicle before and during a refueling process of the motor vehicle is also provided.

The method comprises detecting a request to carry out the refueling process (e.g., while the motor vehicle is stationary).

The method comprises initiating the preparation of the motor vehicle for the refueling process as soon as the request to carry out the refueling process has been detected.

The method comprises activating at least one lighting device and/or output device of the motor vehicle to output at least one first signal as soon as the preparation has been initiated.

The method comprises activating the at least one lighting device and/or output device, either to output at least one second signal if the initiated preparation has been completed without error and the refueling process can be started, or to output at least one third signal if the initiated preparation has not been completed without error and the refueling process is not possible. The at least one first signal, the at least one second signal and the at least one third signal are visual and/or acoustic signals that differ from one another.

The (control) method may be a computer-implemented method, in which one, several or all steps of the method can be carried out at least in part by a computer or a device for data processing, optionally the control device.

What has been described above with reference to the control device and to the motor vehicle also applies analogously to the method and vice versa.

Furthermore, a computer program is provided comprising commands which, when the program is executed by a computer, cause the computer to execute or carry out at least in part the method described above.

A program code of the computer program may be present in any code, in particular in a code which is suitable for controlling motor vehicles.

What has been described above with reference to the control device, to the motor vehicle and to the method also applies analogously to the computer program and vice versa.

Furthermore, a non-transitory computer-readable storage medium is provided. The computer-readable medium comprises commands which, when the commands are executed by a computer, cause the computer to execute or carry out at least in part the method described above.

This means that a computer-readable medium which comprises a computer program defined above may be provided. The computer-readable media may be any digital data storage unit, such as a USB stick, a hard drive, a CD-ROM, an SD card or an SSD card (or SSD drive/SSD hard drive), for example.

The computer program does not necessarily have to be stored on such a computer-readable storage medium in order to be made available to the vehicle, but may also be obtained via the Internet or otherwise externally.

What has been described above with reference to the method, to the control device, to the computer program and to the motor vehicle also applies analogously to the computer-readable medium and vice versa.

An optional embodiment is described below with reference to FIGS. 1 and 2.

### BRIEF DESCRIPTION OF THE DRAWINGS

FIG. 1 schematically shows a motor vehicle according to the disclosure having a control device for controlling operation of the motor vehicle before and during a refueling process of the motor vehicle, and

FIG. 2 schematically shows a flowchart of a method according to the disclosure for controlling operation of the motor vehicle before and during a refueling process of the motor vehicle.

### DETAILED DESCRIPTION OF THE DRAWINGS

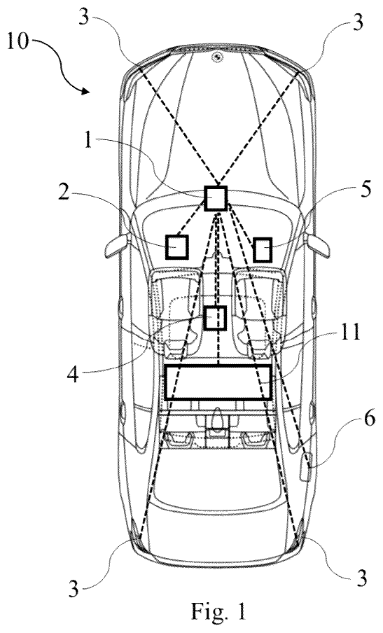

The motor vehicle 10 shown only schematically in FIG. 1 comprises the control device 1, at least one lighting device 3, 4 and at least one output device 5, wherein the control device 1 can be connected for signaling to the at least one lighting device 3, 4 and the at least one output device 5.

The at least one lighting device 3, 4 may comprise an exterior lighting system 3 and an interior lighting system 4 of the motor vehicle 10, while the at least one output device 5 may comprise, for example, a loudspeaker device.

The motor vehicle 10 can comprise a fuel filler cap 6 which can be arranged on an outside of the motor vehicle 10.

The motor vehicle 10 may be a fuel cell vehicle which can comprise a fuel cell system 11 as part of the propulsion system. Accordingly, the motor vehicle 10 can be fueled with hydrogen, for example, via the fuel filler cap 6.

Furthermore, it is conceivable for the motor vehicle 10 to comprise a navigation device 2. The navigation device 2 can be configured to provide a current position of the motor vehicle 10 and digital map data.

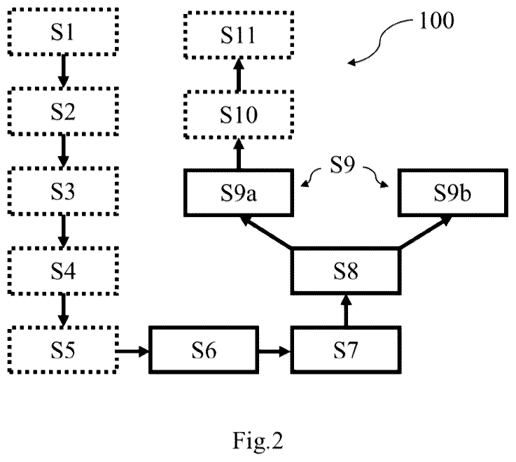

To control operation of the motor vehicle 10 before and during a refueling process of the motor vehicle 10, the control device 1 is configured to carry out the method 100 described in detail below and with reference to FIG. 2.

If the motor vehicle 10 is a fuel cell vehicle 10, it is conceivable to execute the following five steps S1 to S5 of the method 100, wherein the fuel cell vehicle 10 is in a driving mode or in motion.

In the first step S1, a current position of the fuel cell vehicle 10 can be obtained while the fuel cell vehicle 10 is in driving mode.

In the second step S2, digital map data can be retrieved, with the digital map data indicating locations of hydrogen filling stations.

In the third step S3, it can be determined, based on the obtained current position of the fuel cell vehicle 10 and the retrieved digital map data, whether one of the hydrogen filling stations is located in the vicinity of the fuel cell vehicle 10 and/or whether the fuel cell vehicle 10 is approaching one of the hydrogen filling stations.

In the fourth step S4, a potentially imminent refueling process of the fuel cell vehicle 10 can be predicted provided it has been determined that one of the hydrogen filling stations is located in the vicinity of the fuel cell vehicle 10 and/or that the fuel cell vehicle 10 is approaching one of the hydrogen filling stations.

In the fifth step S5, a shutdown of the fuel cell system 11 of the fuel cell vehicle 10 can be initiated, provided that the potentially imminent refueling process has been predicted.

In this case, the shutdown of the fuel cell system 11 can be initiated in such a way that the shutdown process is completed upon arrival at one of the hydrogen filling stations and/or a refueling process of the fuel cell vehicle can be carried out upon arrival at one of the hydrogen filling stations without a waiting time.

The shutdown process of the fuel cell system 11 can be initiated, for example, depending on a driving speed of the fuel cell vehicle 10, a residual distance of the fuel cell vehicle 10 to one of the hydrogen filling stations and/or an expected remaining driving time of the fuel cell vehicle 10 to one of the hydrogen filling stations, for example, such that the shutdown process is completed upon arrival at one of the hydrogen filling stations.

Furthermore, it is conceivable to initiate the shutdown process of the fuel cell system 11 provided that a traction battery of the fuel cell vehicle 10 has a sufficient state of charge for operating an electric motor of the fuel cell vehicle 10 until the fuel cell vehicle 10 can reach one of the hydrogen filling stations.

The following steps S6 to S11 of the method 100 can be carried out when the motor vehicle 10 is stationary, e.g., at a filling station or a hydrogen filling station. To carry out steps S6 to S11 it is not absolutely necessary for the motor vehicle 10 to be a fuel cell vehicle, as is the case with the previous optional steps S1 to S5. In other words, in the following, the motor vehicle 10 may also be, for example, a motor vehicle with an internal combustion engine or a battery-electric motor vehicle. The filling station can also be a classical filling station for (e.g., fossil) fuels and/or an electric charging station.

In the sixth step S6, a request to carry out the refueling process is detected. To this end, the request can be detected by detecting a tapping on and/or an attempt to open a fuel filler cap 6 of the motor vehicle 10. For example, a signal generated by tapping on the fuel filler cap 6 can be obtained from the fuel filler cap 6 or a fuel filler cap device of the motor vehicle 10.

In the seventh step S7, preparation of the motor vehicle 10 for the refueling process is initiated as soon as the request to carry out the refueling process has been detected.

In the eighth step S8 the at least one lighting device 3, 4 and/or output device 5 of the motor vehicle 10 is activated to output at least one first signal as soon as the preparation has been initiated.

In the ninth step S9, which comprises two alternative steps S9a and S9b, the at least one lighting device 3, 4 and/or output device 5 is activated either to output at least one second signal if the initiated preparation has been completed without error and the refueling process can be started (step S9a), or to output at least one third signal if the initiated preparation has not been completed without error and the refueling process is not possible (step S9b). The at least one first signal, the at least one second signal and the at least one third signal are visual and/or acoustic signals that differ from one another.

If the motor vehicle 10 is a fuel cell vehicle, then during the initiated preparation it can be checked whether a shutdown of the fuel cell system 11 of the fuel cell vehicle, which has been initiated, for example, according to the previous optional steps S1 to S5, has been completed without error. If this is the case, i.e., if the shutdown process has been completed without error, it can be determined that the initiated preparation has been completed without error, and (optionally, provided no other fault has occurred) the at least one lighting device 3, 4 and/or output device 5 can be activated according to step S9a to output the at least one second signal. If, on the other hand, an error has occurred during the shutdown process, it can be determined that the initiated preparation has not been completed without error, and the at least one lighting device 3, 4 and/or output device 5 can be activated according to step S9b to output the at least one third signal.

In the tenth step S10 the opening of the fuel filler cap 6 can be initiated and/or permitted if the initiated preparation has been completed without error and the refueling process can be started. For example, the opening can take place simultaneously with the output of the at least one second signal. Thus, the refueling process of the motor vehicle 10 can be carried out.

After the refueling process has been completed, in the eleventh step S11 the at least one lighting device 3, 4 and/or output device 5 can be activated to output at least one fourth signal. The end of the refueling process can be detected, for example, by a closure of the fuel filler cap 6.

As mentioned above, the at least one first signal, the at least one second signal and the at least one third signal, and optionally the at least one fourth signal, are visual and/or acoustic signals that differ from one another.

Thus, the at least one lighting device 3, 4 that comprises the exterior lighting 3 and/or the interior lighting 4 can be configured to output the at least one first signal, the at least one second signal and the at least one third signal as visual signals that differ from one another. Alternatively or in addition, the at least one output device 5 that comprises the loudspeaker device 5 can be configured to output the at least one first signal, the at least one second signal and the at least one third signal as acoustic signals that differ from one another.

So that a user, such as a driver of a motor vehicle 10, can perceive the signals before and during the refueling process when positioned at the fuel filler cap 6, the at least one first signal, the at least one second signal and the at least one third signal can be perceptible outside the motor vehicle 10 and/or at the fuel filler cap 6 of the motor vehicle 10.

For example, the steps S6 to S11 can proceed as follows in the case of a refueling process carried out without errors. The motor vehicle 10 drives to a petrol station or a fuel dispenser at which a user or the driver of the motor vehicle 10 wants to refuel. After parking the motor vehicle 10, the user gets out of the motor vehicle 10, goes to the fuel filler cap 6 and tries to open it, for example, by tapping on it. By attempting to open the fuel filler cap 6, the user thus indicates his/her wish to carry out the refueling process, which is detected in the sixth step S6.

As a result of the detected wish, the preparation for the refueling process is initiated in the seventh step S7 and the user is informed about it in the eighth step S8, in which the at least one lighting device 3, 4 and/or output device 5 (or loudspeaker device 5) is activated to output the at least one first signal.

The at least one first signal may comprise the exterior lighting 3 and/or the interior lighting 4 flashing with a predetermined first frequency and/or the output of a first tone by the loudspeaker device 5. For example, the exterior lighting 3 and the interior lighting 4 can flash simultaneously (or synchronously) at the first frequency, wherein, for example, the interior lighting 4 may have different colors and may flash with a blue-green color, for example.

If the initiated preparation has been completed without error, according to step S9a the at least one second signal is output, which differs from the at least one first signal so that the user recognizes that he/she can start the refueling process. This allows the user to now open the fuel filler cap 6 or the fuel filler cap opens automatically (according to the tenth step S10), so that the user can connect a fuel filler valve to the fuel dispenser and start the refueling process.

The at least one second signal may comprise a permanent illumination of the exterior lighting (e.g., during the entire refueling process). Alternatively, or in addition, the at least one second signal may comprise the output of a second tone, which is different from the first tone, by the loudspeaker device 5 and/or a flaring or a brief strong illumination of the interior lighting 4.

The preparation for the refueling process may vary in duration. If, for example, as described above, the motor vehicle 10 is a fuel cell vehicle, the preparation time depends, inter alia, on a shutdown of the fuel cell system 11. If, for example, the optional steps S1 to S5 of the method 100 have been carried out, the shutdown process can be already completed upon arrival at the filling station or hydrogen filling station, so that the user can start the refueling process without delay, i.e., the preparation time here can be as short as possible, e.g., only a few seconds.

However, if the shutdown of the fuel cell system 11 has not been carried out pre-emptively in accordance with the optional steps S1 to S5, then the shutdown process must be carried out appropriately during the preparation for the refueling process. The user must therefore wait until, for example, they can open the fuel filler cap 6 and start the refueling process.

As long as the at least one third signal is not output, the user knows that the preparation for the refueling process is proceeding normally and that they are likely to be able to start the refueling process immediately. Optionally, it is conceivable to slightly adapt the staging, i.e., the output of the signals, for example by a color adjustment.

At the end of the refueling process, the user removes the dispensing valve and closes the fuel filler cap 6. After the refueling process has been completed, which is detected, e.g., by closure of the fuel filler cap 6, the at least one fourth signal can finally be output according to the eleventh step S11.

The at least one fourth signal can comprise, for example, switching off the exterior lighting 3, outputting a third tone which is different from the first and/or second tone by the loudspeaker device 5, and/or switching off or at least a simple flashing of the interior lighting 4. For example, the third tone may be a confirmation tone that the fuel filler cap is closed. It is conceivable that the loudspeaker device 5 also outputs a fourth tone before the end of the refueling process, which is different from the third tone and can be, for example, a confirmation tone that the tank of the motor vehicle 10 is full.

In the event of an error, if the refueling process is not possible, steps S6 to S8 can initially proceed as described above.

If, in contrast to the error-free execution of the refueling process described, however, a fault occurred during the initiated preparation, then instead of the at least one second signal, the at least one third signal according to step S9b is output, which differs from the at least one first signal and the at least one second signal. This allows the user to recognize that the refueling process is not possible and that they may have to take countermeasures to correct the fault. Accordingly, the fuel filler cap 6 remains unable to be opened or does not open automatically.

The at least one third signal can include flashing of the exterior lighting 3 and/or the interior lighting 4 with a predetermined second sequence which differs from the first frequency, and optionally subsequently switching off the exterior lighting 3 and/or interior lighting 4. Alternatively or in addition, the at least one third signal can comprise the output of a warning tone by the loudspeaker device 5.

In addition, it is conceivable for a display screen (not shown) in the interior of the motor vehicle 10 to output an error message and, for example, information about the fault and instructions for correcting the fault. This means that the user can be informed both in the interior, where they can receive further instructions, and at the fuel filler cap 6 that a fault has occurred. Accordingly, the user can, for example, call for further assistance.

### LIST OF REFERENCE SIGNS

1 Control device
2 Navigation device
3 Lighting device, exterior lighting
4 Lighting device, interior lighting
5 Output device, loudspeaker device
6 Fuel filler cap
10 Motor vehicle, e.g. fuel cell vehicle
11 Fuel cell system
100 Method
S1-S11 Method steps

What is claimed is:

1. A control device configured to control operation of a motor vehicle before and during a refueling process of the motor vehicle, wherein the control device is configured to:
detect a request to carry out the refueling process;
initiate preparation of the motor vehicle for the refueling process as soon as the request to carry out the refueling process has been detected;
activate at least one lighting device and/or output device of the motor vehicle to output at least one first signal as soon as the preparation has been initiated; and
activate the at least one lighting device and/or output device, to either
output at least one second signal if the preparation has been completed without error and the refueling process can be started, or
output at least one third signal if the preparation has not been completed without error and the refueling process is not possible, wherein the at least one first signal, the at least one second signal and the at least one third signal are visual and/or acoustic signals that differ from one another.

2. The control device according to claim 1, wherein the motor vehicle is a fuel cell vehicle and the control device is configured to:
verify during the preparation that a shutdown of a fuel cell system of the fuel cell vehicle has been completed without error; and
determine that the preparation has been completed without error provided that the shutdown has been completed without error.

3. The control device according to claim 1, wherein the control device is configured to detect the request to carry out the refueling operation by detecting a tapping on and/or an attempt to open a fuel filler cap of the motor vehicle.

4. The control device according to claim 2, wherein the control device is configured to detect the request to carry out the refueling operation by detecting a tapping on and/or an attempt to open a fuel filler cap of the motor vehicle.

5. The control device as claimed in claim 1, wherein the at least one first signal, the at least one second signal and the at least one third signal are perceptible outside the motor vehicle and/or at a fuel filler cap of the motor vehicle.

6. The control device as claimed in claim 2, wherein the at least one first signal, the at least one second signal and the at least one third signal are perceptible outside the motor vehicle and/or at a fuel filler cap of the motor vehicle.

7. The control device as claimed in claim 3, wherein the at least one first signal, the at least one second signal and the at least one third signal are perceptible outside the motor vehicle and/or at a fuel filler cap of the motor vehicle.

8. The control device according to claim 1, wherein the control device is configured to initiate and/or permit opening of a fuel filler cap of the motor vehicle when the preparation has been completed without error and the refueling process can be started.

9. The control device according to claim 2, wherein the control device is configured to initiate and/or permit opening of a fuel filler cap of the motor vehicle when the preparation has been completed without error and the refueling process can be started.

10. The control device according to claim 3, wherein the control device is configured to initiate and/or permit opening of a fuel filler cap of the motor vehicle when the preparation has been completed without error and the refueling process can be started.

11. The control device according to claim 5, wherein the control device is configured to initiate and/or permit opening of a fuel filler cap of the motor vehicle when the preparation has been completed without error and the refueling process can be started.

12. The control device according to claim 1, wherein the control device is configured to activate the at least one lighting device and/or output device to output at least one fourth signal when the refueling process has been completed.

13. The control device according to claim 2, wherein the control device is configured to activate the at least one lighting device and/or output device to output at least one fourth signal when the refueling process has been completed.

14. The control device according to claim 3, wherein the control device is configured to activate the at least one lighting device and/or output device to output at least one fourth signal when the refueling process has been completed.

15. The control device according to claim 5, wherein the control device is configured to activate the at least one lighting device and/or output device to output at least one fourth signal when the refueling process has been completed.

16. The control device according claim 1, wherein
the at least one lighting device comprises an exterior light and/or an interior light of the motor vehicle configured to output the at least one first signal, the at least one second signal and the at least one third signal as visual signals that differ from one another, and/or
the at least one output device comprises a loudspeaker device of the motor vehicle configured to output the at least one first signal, the at least one second signal and the at least one third signal as acoustic signals that differ from one another.

17. The control device according claim 2, wherein
the at least one lighting device comprises an exterior light and/or an interior light of the motor vehicle configured to output the at least one first signal, the at least one second signal and the at least one third signal as visual signals that differ from one another, and/or
the at least one output device comprises a loudspeaker device of the motor vehicle configured to output the at least one first signal, the at least one second signal and the at least one third signal as acoustic signals that differ from one another.

18. A motor vehicle comprising a control device according to claim 1.

19. A method for controlling operation of a motor vehicle before and during a refueling process of the motor vehicle, the method comprising:
detecting a request to carry out the refueling process;
initiating preparation of the motor vehicle for the refueling process as soon as the request to carry out the refueling process has been detected;
activating at least one lighting device and/or output device of the motor vehicle to output at least one first signal as soon as the preparation has been initiated; and
activating the at least one lighting device and/or output device, to either
output at least one second signal if the preparation has been completed without error and the refueling process can be started, or
output at least one third signal if the preparation has not been completed without error and the refueling process is not possible, wherein the at least one first signal, the at least one second signal and the at least one third signal are visual and/or acoustic signals that differ from one another.

20. A non-transitory computer-readable medium storing commands which, when executed by a computer, cause the computer to execute a method comprising:
detecting a request to carry out the refueling process;
initiating preparation of the motor vehicle for the refueling process as soon as the request to carry out the refueling process has been detected;
activating at least one lighting device and/or output device of the motor vehicle to output at least one first signal as soon as the preparation has been initiated; and
activating the at least one lighting device and/or output device, to either
output at least one second signal if the preparation has been completed without error and the refueling process can be started, or
output at least one third signal if the preparation has not been completed without error and the refueling process is not possible, wherein the at least one first signal, the at least one second signal and the at least one third signal are visual and/or acoustic signals that differ from one another.
